(19) United States
(12) Patent Application Publication
(10) Pub. No.: US 2026/0020942 A1
(43) Pub. Date: Jan. 22, 2026

(54) IMAGE PROCESSING METHOD AND IMAGE PROCESSING SYSTEM FOR DETECTING AN OBJECT USING MARKER-LINE PATTERNS AND SCAN-LINE PATTERNS

(71) Applicant: QISDA CORPORATION, Taoyuan City (TW)

(72) Inventors: Ching-Huey Wang, Taoyuan City (TW); Tsung-Hsun Wu, Taoyuan City (TW)

(73) Assignee: QISDA CORPORATION, Taoyuan City (TW)

(21) Appl. No.: 19/015,549

(22) Filed: Jan. 9, 2025

(30) Foreign Application Priority Data
Jul. 19, 2024 (CN) 202410970860.1

(51) Int. Cl. A61C 9/00

(52) U.S. Cl. CPC A61C 9/006

(57) ABSTRACT

An image processing method includes performing a coding operation to generate a first code to a W-th code according to W regions of a pattern generator; generating a first scan-line pattern to an I-th scan-line pattern, where the first scan-line pattern to the I-th scan-line pattern includes multiple scan-lines, and each scan-line is corresponding to one of the first code to the W-th code; projecting the first scan-line pattern to the I-th scan-line pattern onto an object within a first predetermined period; and generating a three-dimensional image of the object according to the first scan-line pattern to the I-th scan-line pattern reflected by the object. A duration of projecting and exposing the first scan-line pattern to the I-th scan-line pattern onto the object is a first operating period, and the first predetermined period is less than 110% of the first operating period.

### BACKGROUND OF THE INVENTION

### 1. Field of the Invention

The disclosure is related to an image processing method and an image processing system, and more particularly, to an image processing method and an image processing system capable of performing an encoding operation, generating scan-line patterns, generating marker-line patterns, and detecting objects accordingly.

### 2. Description of the Prior Art

With the advancement of technology, more and more professionals are beginning to use optical auxiliary devices to improve operational convenience and accuracy. For example, in the field of dentistry, intraoral scanners are currently available to assist dentists in examining the oral cavity. Intraoral scanners can capture images inside the mouth and convert them into digital data to help dentists and prosthetic technicians in diagnosing and producing prosthetics.

When using an intraoral scanner to obtain images of teeth, the scanner can be continuously moved to capture multiple images and stitch them together to generate a more complete three-dimensional image.

It has been observed that generated three-dimensional images frequently suffer from inaccurate deformations. According to analysis, poor quality three-dimensional images are often the result of the scanner moving too quickly or unexpected linear or angular displacements caused by the user's hand shaking during scanning. These displacements disrupt image decoding accuracy, leading to poor-quality three-dimensional images.

### SUMMARY OF THE INVENTION

An embodiment provides an image processing method for detecting an object. The method includes (a) performing an encoding operation to generate a first code to a W-th code according to W regions of a pattern generator, (b) generating a first scan-line pattern to an I-th scan-line pattern, wherein the first scan-line pattern to the I-th scan-line pattern each comprise a plurality of scan-lines, and each scan-line is corresponding to one of the first code to the W-th code, respectively, (c) projecting the first scan-line pattern to the I-th scan-line pattern onto the object within a first predetermined period, and (d) generating a three-dimensional image of the object according to the first scan-line pattern to the I-th scan-line pattern reflected by the object. At least a first operation period is required for projecting the first scan-line pattern to the I-th scan-line pattern onto the object, and the first predetermined period is less than 110% of the first operation period. W is an integer greater than zero, and I is an integer greater than 1.

Another embodiment provides an image processing system for detecting an object. The system includes a projection light source, a pattern generator, an imaging unit, and a control unit. The projection light source is used to generate projection light. The pattern generator is used to use the projection light to generate a first scan-line pattern to an I-th scan-line pattern, where each of the first scan-line pattern to the I-th scan-line pattern comprises a plurality of scan-lines. The imaging unit is used to project the first scan-line pattern to the I-th scan-line pattern onto the object within a first predetermined period, and to receive the first scan-line pattern to the I-th scan-line pattern reflected by the object. The control unit is used to perform an encoding operation to generate a first code to a W-th code according to W regions of the pattern generator, arrange each scan-line to be corresponding to one of the first code to the W-th code respectively, and generate a three-dimensional image of the object according to the first scan-line pattern to the I-th scan-line pattern reflected by the object. At least a first operation period is required for projecting the first scan-line pattern to the I-th scan-line pattern onto the object, and the first predetermined period is less than 110% of the first operation period. W is an integer greater than zero, and I is an integer greater than 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of an image processing system according to an embodiment.

FIG. 2 shows a flowchart of an image processing method according to an embodiment.

FIG. 3 shows a flowchart of an image processing method according to another embodiment.

FIG. 4 shows a schematic diagram of performing an encoding operation as shown in FIG. 1 and FIG. 3.

FIG. 5 shows an example of arranging a plurality of scan-line patterns into a plurality of scan-line two-dimensional spaces.

FIG. 6 shows a schematic diagram of adjusting the line widths according to an embodiment.

FIG. 7 to FIG. 9 show schematic diagrams of the alignment of the scan-line and the corresponding marker-line of FIG. 1 according to different embodiments.

FIG. 10 shows a timing diagram for projecting a plurality of scan-line patterns and a plurality of marker-line patterns onto an object according to an embodiment.

### DETAILED DESCRIPTION

To further understand the objectives, structures, features, and functions of the present disclosure, a detailed description is provided below in conjunction with the embodiments.

Certain terms are used in the specification and claims to refer to specific elements. It will be understood by those skilled in the art that manufacturers may refer to the same element with different terms. This specification and claims do not distinguish elements by the names but by their functional differences. The term “include” as mentioned throughout the specification and claims is open-ended and should be interpreted as “including but not limited to.” Likewise, the terms “comprise” and “have” are also open-ended expressions.

The ordinal numbers such as “first,” “second,” “third,” etc., used in the text are for describing elements. They do not imply any particular sequence or order of the elements, nor do they denote any procedural steps. The use of these ordinal numbers is solely for the purpose of clearly distinguishing one element with a particular name from another element with the same name.

The line patterns described herein may be light patterns. The lines described herein may be line-shaped light. According to embodiments, scan-line patterns may be projected onto an object (e.g., a tooth), and the reflected scan-line patterns from the object may be received. Based on the distribution of the scan-lines in the reflected scan-line patterns, the shape of the object may be analyzed, and a three-dimensional image of the object may be generated. However, to more accurately recognize and decode the reflected scan-lines, in a preferred embodiment, marker-line patterns may be additionally projected onto the object, and the reflected marker-line patterns may be received. The reflected marker-lines can be used to more accurately locate the reflected scan-lines. The solution provided by embodiments is intended to improve the accuracy of recognizing and decoding the reflected line patterns, thereby enhancing the quality of the generated three-dimensional images.

In the text, each scan-line pattern may comprise a set of scan-lines and correspond to a scan-line two-dimensional space. According to an embodiment, each marker-line pattern may comprise a set of marker-lines and correspond to a marker-line two-dimensional space.

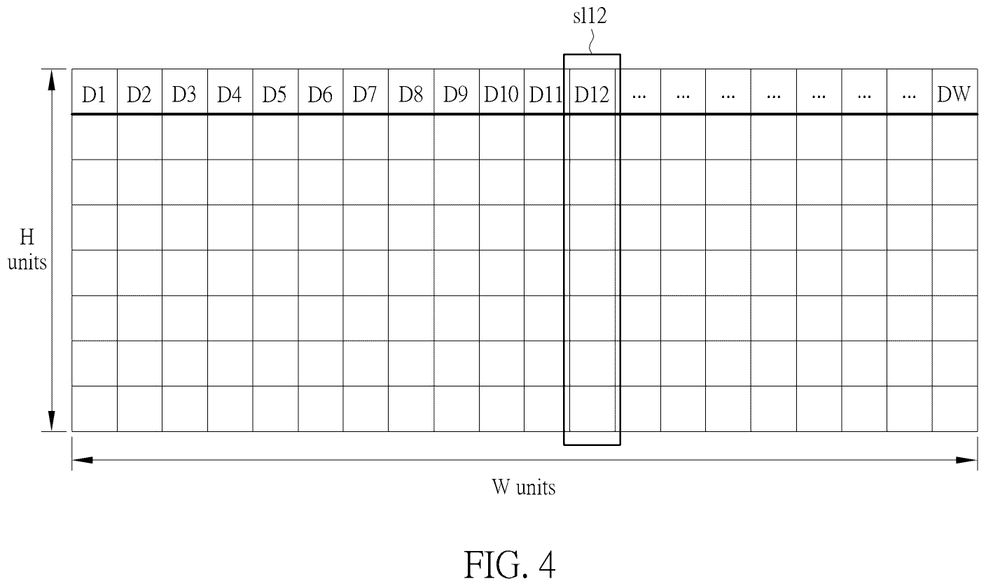

Each scan-line may have a code, and in one embodiment, each marker-line may have a code. The codes described here may be generated by an encoding operation, with each code corresponding to a region and position in a two-dimensional space. The encoding operation will be further described with reference to FIG. 4. In the text, a scan-line may be represented as “sl”, and a marker-line may be represented as “ml”. For example, if referring to “scan-line slα,” where α may be an integer indicating the code and position corresponding to the scan-line. Similarly, if referring to “marker-line mlβ,” where β may be an integer indicating the code and position corresponding to the marker-line.

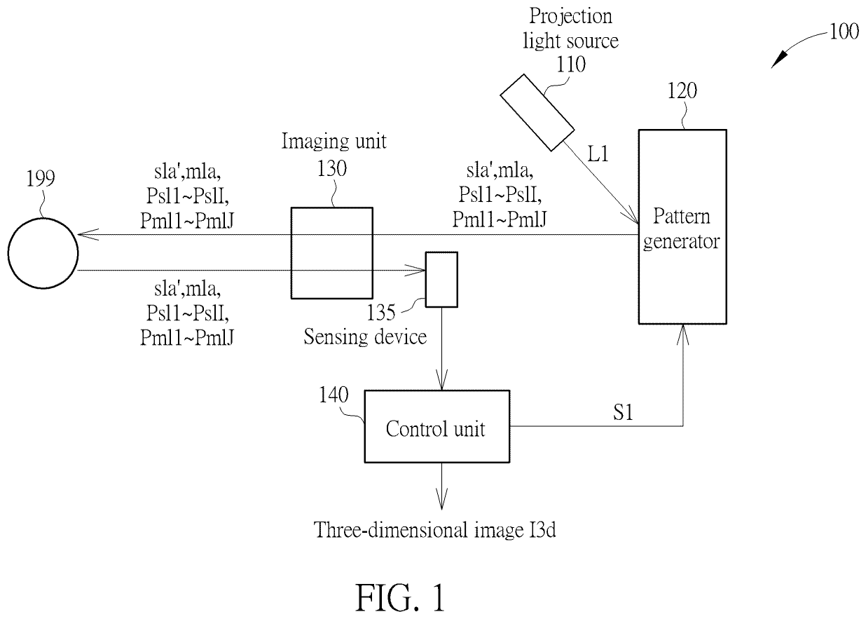

FIG. 1 shows a schematic diagram of an image processing system 100 according to an embodiment. The image processing system 100 may detect the three-dimensional shape of an object 199 and may include a projection light source 110, a pattern generator 120, an imaging unit 130, a sensing device 135, and a control unit 140.

The projection light source 110 may generate projection light L1. The pattern generator 120 may use the projection light L1 to generate I scan-line patterns Psl1 to PslI. In an embodiment, the pattern generator 120 may also use the projection light L1 to generate J marker-line patterns Pml1 to PmlJ.

In an embodiment, the two-dimensional space of the pattern generator 120 may be a digital micromirror device (DMD) plane, a liquid crystal display (LCD) plane, or another type of hardware plane. For example, if the pattern generator 120 has a horizontal width of 1280 pixels and a vertical length of 720 pixels, it may generate 1280 scan-lines (e.g., represented as sl1 to sl1280).

The imaging unit 130 may project I scan-line patterns Psl1 to PslI within a predetermined period. In an embodiment, the imaging unit 130 may also project J marker-line patterns Pml1 to PmlJ onto the object 199. The imaging unit 130 may receive the line patterns reflected by the object 199. As shown in FIG. 1, a scan-line sla′ and a corresponding marker-line mla may also be projected onto the object 199.

The sensing device 135 may receive the scan-line patterns Psl1 to PslI, the marker-line patterns Pml1 to PmlJ, the scan-line sla′, and the marker-line mla reflected by the object 199, and transmit signals to the control unit 140 to generate a three-dimensional image of the object 199 accordingly.

The control unit 140 may output data S1 corresponding to the encoding operation, the scan-line patterns, and the marker-line patterns. The control unit 140 may perform an encoding operation to generate multiple codes and generate a three-dimensional image (represented as I3d) of the object 199 based on the line patterns reflected by the object 199. The control unit 140 may utilize the marker-line patterns Pml1 to PmlJ to enhance the accuracy in identifying the scan-line patterns Psl1 to PslI. Additionally, the marker-line mla can be used to enhance the accuracy in identifying the scan-line sla′. In FIG. 1, I and J may be integers greater than zero, with further details provided later in the document.

In an embodiment, in FIG. 1, corresponding to the concave and convex shapes of the surface of the object 199, the lines in the scan-line patterns Psl1 to PslI and the marker-line patterns Pml1 to PmlJ reflected by the object 199 may not be straight but curved, and be corresponding to multiple coordinate positions. The control unit 140 can better identify the coordinate positions of the corresponding scan-line (e.g., sla′) based on the marker-line (e.g., mla) to improve the accuracy of detecting the object 199.

In FIG. 1, the lenses of the imaging unit 130 used for projecting the lines and the lenses used for receiving the lines can be the same set of lenses or different sets of lenses.

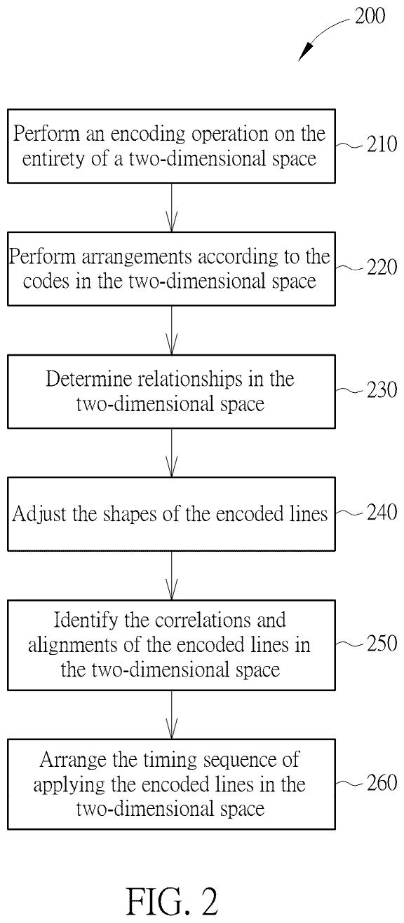

FIG. 2 shows a flowchart of an image processing method 200 according to a preferred embodiment. The image processing method 200 may correspond to FIG. 1 and include the following steps.
Step 210: Perform an encoding operation on the entirety of a two-dimensional space;
Step 220: Perform arrangements according to the codes in the two-dimensional space;
Step 230: Determine relationships in the two-dimensional space;
Step 240: Adjust the shapes of the encoded lines;
Step 250: Identify the correlations and alignments of the encoded lines in the two-dimensional space; and
Step 260: Arrange the timing sequence of applying the encoded lines in the two-dimensional space.

The above steps may be performed sequentially, or the order of the steps may be selectively adjusted while still falling within the scope of embodiments. In Step 210, multiple regions of the two-dimensional space of the pattern generator 120 in FIG. 1 may be encoded so that each region has a code, thereby generating multiple codes.

In Step 220, multiple two-dimensional spaces may be established. Each of the I scan-line patterns Psl1 to PslI in FIG. 1 may correspond to a scan-line two-dimensional space (denoted as 2Dsl). Each of the J marker-line patterns Pml1 to PmlJ in FIG. 1 may correspond to a marker-line two-dimensional space (denoted as 2Dml). Each scan-line two-dimensional space (2Dsl) may correspond to a set of scan-lines, and each marker-line two-dimensional space (2Dml) may correspond to a set of marker-lines. Each of the aforementioned scan-lines and marker-lines may have one of the codes generated in Step 210. Step 220 can be expressed as 2Dsl∈code and 2Dml∈code.

In Step 230, the relationship between the scan-lines and the marker-lines may be established, which can be represented as R∈(2Dsl,2Dml), where R may represent the relationship.

In Step 240, according to requirements, the widths of the scan-lines and/or marker-lines may be adjusted, and this step can be represented as width (code).

In Step 250, the alignment of the scan-lines and marker-lines can be adjusted, and it can be represented as code (Edge∥Center), where Edge can describe the boundary of the lines and Center can describe the centerline of the lines.

In Step 260, the sequence for projecting multiple scan-line patterns and multiple marker-line patterns can be set. For example, it can be represented as sequence ({2Dml}, {2Dsl}).

The various representations mentioned above are merely examples, and other representations may also be used for definition and description. Relevant details are described below.

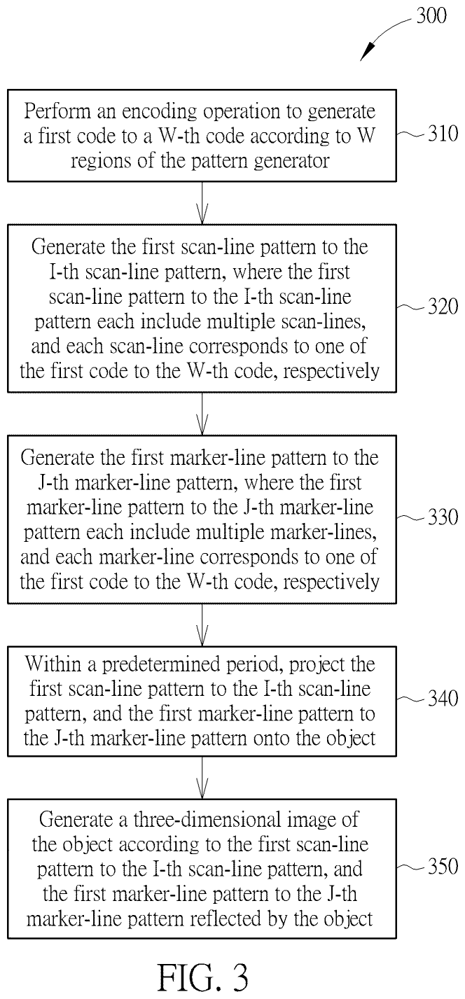

FIG. 3 shows a flowchart of an image processing method 300 according to a preferred embodiment. The image processing method 300 may correspond to the image processing system 100 and the image processing method 200, and may include the following steps.
Step 310: Perform an encoding operation to generate a first code to a W-th code according to W regions of the pattern generator 120 in FIG. 1;
Step 320: Generate the first scan-line pattern Psl1 to the I-th scan-line pattern PslI, where the first scan-line pattern Psl1 to the I-th scan-line pattern PslI each include multiple scan-lines, and each scan-line corresponds to one of the first code to the W-th code, respectively;
Step 330: Generate the first marker-line pattern Pml1 to the J-th marker-line pattern PmlJ, where the first marker-line pattern Pml1 to the J-th marker-line pattern PmlJ each include multiple marker-lines, and each marker-line corresponds to one of the first code to the W-th code, respectively;
Step 340: Within a predetermined period (denoted as Td), project the first scan-line pattern Psl1 to the I-th scan-line pattern PslI, and the first marker-line pattern Pml1 to the J-th marker-line pattern PmlJ onto the object 199; and
Step 350: Generate a three-dimensional image I3d of the object 199 according to the first scan-line pattern Psl1 to the I-th scan-line pattern PslI, and the first marker-line pattern Pml1 to the J-th marker-line pattern PmlJ reflected by the object 199.

As shown in FIG. 2 and FIG. 3, Step 310 may correspond to Step 210, Steps 320 and 330 may correspond to Steps 220 to 250, and Steps 340 and 350 may correspond to Step 260.

An a-th marker-line (e.g., the marker-line mla in FIG. 1) of multiple marker-lines of the marker-line patterns may be corresponding to an a′-th scan-line (e.g., scan-line sla′ in FIG. 1) of multiple scan-lines of the multiple scan-line patterns. The a-th marker-line mla reflected by the object 199 may be used to identify the a′-th scan-line sla′ reflected by the object 199. The abovementioned W, a, and a′ may be integers greater than zero, I may be an integer greater than or equal to 2, J may be an integer greater than or equal to 1, a≤W, and a′≤W.

For example, the a-th marker-line mla may be wider, allowing the imaging unit 130 and the control unit 140 to recognize the a-th marker-line mla more efficiently. The control unit 140 can use the position of the a-th marker-line mla to identify the corresponding a′-th scan-line sla′, thereby increasing the success rate and accuracy of scan-line recognition.

In FIG. 1 and Step 340 of FIG. 3, when projecting each of the scan-line pattern PslI to PslI and the marker-line pattern Pml1 to PmlJ onto the object 199, the required duration may be an operation period. The predetermined period Td may be less than 103%, 105%, or 110% of the (I+J) times the operation period.

When projecting the scan-line pattern and the corresponding marker-line pattern onto the object 199, the ideal scenario is simultaneous projection without any time lag. Without a time lag, both the scan-line pattern and the marker-line pattern can be corresponding to the same part of the object 199, thereby improving the accuracy of using the marker pattern to assist in the recognition of the scan pattern.

In practice, the time lag between projecting the marker-line mla and the scan-line sla′ should not be too large. This is to avoid significant differences between the parts of the object 199 corresponding to the marker-line mla and the scan-line sla′, which would make it difficult to use the marker-line mla to identify the position of the scan-line sla′. Due to hardware limitations, multiple patterns may not be projected simultaneously and must be projected sequentially. Therefore, the upper limit of the predetermined period Td can be restricted to ensure that the time lag between projecting the scan-line pattern and the corresponding marker-line pattern is not too large, thus ensuring the accuracy of using the marker-line to identify the scan-line.

The scan-line patterns PslI to PslI and the marker-line patterns Pml1 to PmlJ may be light patterns with the same wavelength and can be projected sequentially. In another embodiment, one scan-line pattern among the scan-line patterns PslI to PslI may be corresponding to a first light wavelength, and one marker-line pattern among the marker-line patterns Pml1 to PmlJ may be corresponding to a second light wavelength. The first light wavelength and the second light wavelength can be the same or different. For example, the scan-line pattern may be corresponding to infrared light, and the marker-line pattern may be corresponding to ultraviolet light. If the reflected scan-line pattern and marker-line pattern can be distinguished for subsequent processing, then both patterns can substantially be projected onto the object 199 at the same time.

FIG. 4 shows a schematic diagram of the encoding operation performed in the aforementioned Steps 110 and 310. FIG. 4 is merely an example to aid in explanation, and embodiments are not limited thereto. If the number of codes differs from FIG. 4, it is still within the scope of embodiments. In FIG. 4, the horizontal width of the two-dimensional plane of the pattern generator 120 may be W units, and the vertical height may be H units. For example, one unit may be one pixel. As shown in FIG. 4, the two-dimensional plane of the pattern generator 120, along the horizontal direction, may have W regions that may be encoded as the first code (denoted as D1) to the W-th code (denoted as DW).

As an example, if W=480, the encoded codes may range from D1 to D480. Each code-corresponding region may have a horizontal width and vertical length. For example, the width may be one pixel, and the length may be H pixels. In the example of FIG. 4, the scan-line sl12 may have the code D12.

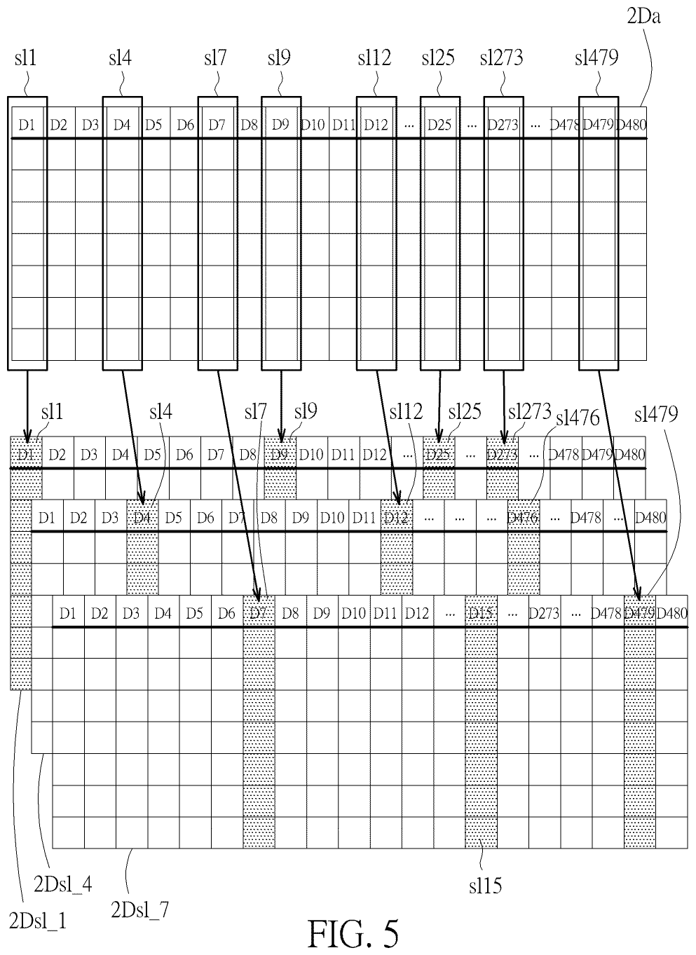

FIG. 5 shows an example related to Step 220 in FIG. 2 and Step 320 in FIG. 3. FIG. 5 describes how to set the codes and regions corresponding to multiple scan-lines, and how to arrange multiple scan-lines into multiple scan-line two-dimensional spaces. FIG. 5 is merely an example to aid in explanation, and embodiments are not limited thereto. In FIG. 5, a two-dimensional space 2Da may be a two-dimensional space of the pattern generator 120. Through the encoding operation, a total of 480 regions from left to right may have the codes D1 to D480, respectively. FIG. 5 may represent the case of I=3 in the aforementioned Step 320. In FIG. 5, there are three scan-line two-dimensional spaces, which may be denoted as 2Dsl_1, 2Dsl_4, and 2Dsl_7. In FIG. 5, multiple scan-lines may be assigned to the three scan-line two-dimensional spaces, forming three scan-line patterns.

In the example of FIG. 5, multiple scan-lines may be denoted as slx+cy, where sl represents scan-lines, and x+cy may be the codes of the scan-lines, describing the positions of the scan-lines in the pattern, where x, c, and y may be integers.

Corresponding to the first scan-line two-dimensional space 2Dsl_1 in FIG. 5, x may be 1, y may be 8, and c may be integer parameters ranging from 0 to 59. Hence, the multiple scan-lines (slx+cy) in the scan-line two-dimensional space 2Dsl_1 may include sl1, sl9, sl17, sl25, . . . , sl273, . . . , and sl473.

Corresponding to the second scan-line two-dimensional space 2Dsl_4 in FIG. 5, x may be 4, y may be 8, and c may be integer parameters ranging from 0 to 59. Hence, the multiple scan-lines (slx+cy) in the scan-line two-dimensional space 2Dsl_4 may include sl4, sl12, sl20, sl28, . . . , and sl476.

Corresponding to the third scan-line two-dimensional space 2Dsl_7 in FIG. 5, x may be 7, y may be 8, and c may be integer parameters ranging from 0 to 59. Hence, the multiple scan-lines (slx+cy) in the scan-line two-dimensional space 2Dsl_7 may include sl7, sl15, sl23, sl31, . . . , and sl479.

The scan-line two-dimensional spaces 2Dsl_1, 2Dsl_4, and 2Dsl_7 in FIG. 5 may be used to generate three scan-line patterns for projecting onto the object 199.

FIG. 5 is an example, and if described in general terms, it can be as follows: The i-th scan-line pattern (denoted as Psli) from the first scan-line pattern Psl1 to the I-th scan-line pattern PslI may include multiple scan-lines. The multiple scan-lines of the i-th scan-line pattern Psli may be corresponding to multiple codes, where a k-th code may be denoted as f(xᵢ, cₖ). The said f( ) may be a first predetermined function, where i, xᵢ, and k may be integers greater than zero, and cₖ may be an integer not less than zero. The k-th code may be corresponding to one of the first code (e.g., D1) to the W-th code (e.g., D480). In the above, 0<i≤I, k≤W, xᵢ may be a parameter that changes with i, and cₖ may be a parameter that changes with k.

According to embodiments, the aforementioned function f(xᵢ, cₖ) may be f(xᵢ, cₖ)=xᵢ+cₖ×y, where y may be an integer greater than zero. In the above, the parameter xᵢ may represent the starting position of the multiple scan-lines in the i-th scan-line pattern. The parameter cₖ may represent the number of pixels between two adjacent scan-lines in the corresponding scan-line pattern. The parameter y may represent the ordinal number of each scan-line. In this way, the control unit 140 may use the first predetermined function to determine the codes and positions of the multiple scan-lines in the multiple scan-line patterns.

The above describes how to determine the codes and positions of the scan-lines. Regarding the marker-lines, similar to the scan-lines, each marker-line may also have a code to describe its position in the two-dimensional space of the marker-line pattern.

In Step 330 of FIG. 3, each of the multiple marker-lines in the marker-line patterns Pml1 to PmlJ may be arranged into one marker-line pattern of the marker-line patterns Pml1 to PmlJ. According to other embodiments, each marker-line may be arranged into one or more marker-line patterns, as illustrated below. For example, if there are two marker-line patterns Pml1 and Pml2, corresponding to two marker-line two-dimensional spaces (referred to as 2Dml_1 and 2Dm_2), the arrangement may be as described in Table 1.

TABLE 1
The marker-line pattern Pml1 (corresponding to the marker-line
two-dimensional space 2Dml_1) may include:
marker-lines ml1, ml17, ml49, ml65, m181, ml113, ml129, ml145, ml177,
ml193, ml209 . . .
The marker-line pattern Pml2 (corresponding to the marker-line
two-dimensional space 2Dml_2) may include:
marker-lines ml1, ml33, ml65, ml97, ml129, ml161, ml193 . . .

In the example of Table 1, the marker-lines ml17, ml49, ml81, etc., may be arranged only into the marker-line pattern Pml1. The marker-lines ml33, m197, ml161, etc., may be arranged only into the marker-line pattern Pm12. The marker-lines ml1, m165, ml129, ml193, etc., may be arranged into both marker-line patterns Pml1 and Pml2, rather than being arranged into a single marker-line pattern. Thus, marker-lines may be arranged into suitable one or more marker-line patterns as required.

Regarding the multiple marker-lines mentioned in Step 330 of FIG. 3, if described in general terms, their corresponding codes and regions can be as follows. Among the multiple codes corresponding to the multiple marker-lines, the k′-th code may be denoted as g(ck′), and g(ck′) may be a second predetermined function. A k′-th code may be corresponding to one of the first code to the W-th code, where k′ may be a positive integer greater than zero, ck′ may be a non-negative integer, k′≤W, and ck′ is a parameter that changes with k′.

According to the embodiment, g(c_{k′}) may be set as g(c_{k′})=x′+c_{k′}×y′, where x′ and y′ may be parameters corresponding to the marker-line patterns of the first scan-line pattern to the I-th scan-line pattern, and x′ and y′ may be integers greater than zero.

For example, the k′-th marker-line among the multiple marker-lines may be denoted as ml g(c_{k′}). If g(c_{k′}) is set as g(c_{k′})=x′+c_{k′}×y′, where x′ is 1, and y′ is 8, then g(c_{k′}) may be g(c_{k′})=1+c_{k′}×8.

In this example, c_{k′} may be (k′−1)×T, where T may be an integer greater than zero. For instance, if T=2, then c_{k′} may be set as (k′−1)×2. Thus, c_{k′} may be 0, 2, 4, 6, 8, etc. The arrangement of marker-lines may be as described in Table 2 corresponding to Table 1.

TABLE 2

| k′ | 1 | 2 | 3 | 4 | 5 | . . . |
|---|---|---|---|---|---|---|
| ck′ | 0 | 2 | 4 | 6 | 8 | . . . |
| The | ml1 | ml17 | ml33 | ml49 | ml65 | . . . |
| corresponding | (corresponding | (corresponding | (corresponding | (corresponding | (corresponding | |
| k′-th marker-line | to the | to the | to the | to the | to the | |
| | code D1) | code D17) | code D33) | code D49) | code D65) | |
| The | Pml1 | Pml1 | Pml2 | Pml1 | Pml1 | . . . |
| corresponding | Pml2 | | | | Pml2 | |
| marker-line | | | | | | |
| pattern(s) | | | | | | |
| The | 2Dml1 | 2Dml1 | 2Dml2 | 2Dml1 | 2Dml1 | . . . |
| corresponding | 2Dml2 | | | | 2Dml2 | |
| marker-line | | | | | | |
| two-dimensional | | | | | | |
| space(s) | | | | | | |

Tables 1 and 2 are merely examples. In another embodiment, if the aforementioned T is 3, then c_{k′} may be set as (k′−1)×3. Corresponding to k′ being 1, 2, 3, 4, 5, 6, etc., c_{k′} can be 0, 3, 6, 9, 12, 15, etc., and the codes of the marker-lines may be adjusted accordingly. For example, the code of the k′-th marker-line may be 1+ck′×8. Therefore, the resulting k′-th marker-line may include ml1, ml25, ml49, ml73, ml97, ml121, etc., which differs from the content of Table 2.

Tables 1 and 2 are merely examples, illustrating that multiple marker-lines can be generated. The control unit 140 may use the second predetermined function and arrange each marker-line into the appropriate marker-line pattern respectively as needed to project onto the object 199 for detection.

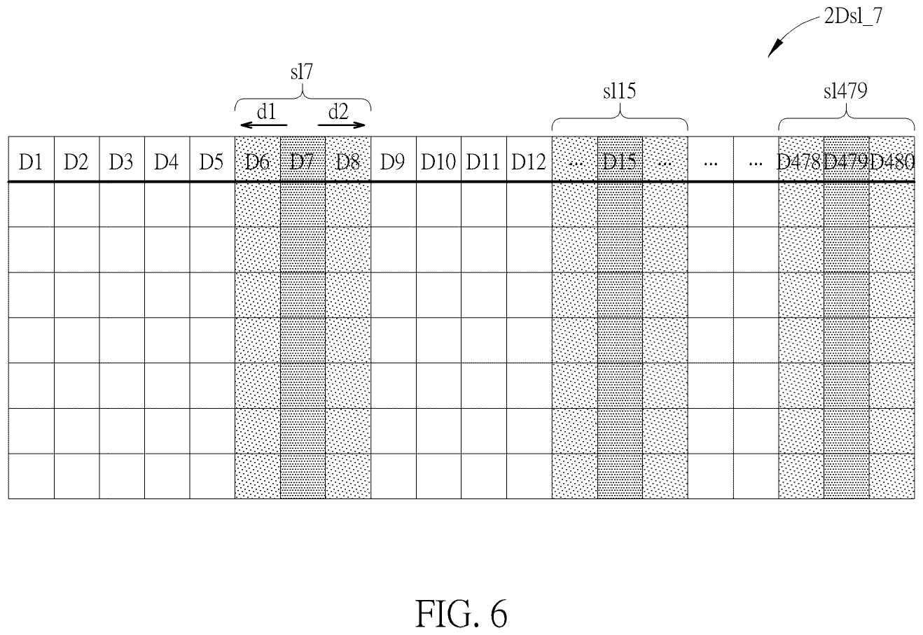

FIG. 6 shows a diagram of adjusting line width in the embodiment. FIG. 6 may be related to Step 240 of FIG. 2 and Step 320 and Step 330 of FIG. 3. FIG. 6 may be corresponding to the scan-line two-dimensional space 2Dsl_7 of FIG. 5, which includes the scan-line sl7 (corresponding to the code D7), the scan-line sl15 (corresponding to the code D15), and the scan-line sl479 (corresponding to the code D479). The adjustment of the line width may include the following various operations.
(Operation 1) As shown in FIG. 5, each scan-line is 1 pixel wide, or of a predetermined width, without further adjustment;
(Operation 2) As shown in direction d1 of FIG. 6, increase the line width to the left;
(Operation 3) As shown in direction d2 of FIG. 6, increase the line width to the right; and
(Operation 4) As shown in directions d1 and d2 of FIG. 6, increase the line width to both left and right sides.

The above operations 1 to 4 may be selectively performed. Some lines may be adjusted according to one of Operations 1 to 4, while other lines may be adjusted according to another of Operations 1 to 4. All of the above fall within the scope of embodiments.

In the example of FIG. 6, Operation 4 is applied as an example. In FIG. 5 and FIG. 6, each scan-line in FIG. 5 is 1 pixel wide, while the width of each scan-line in FIG. 6 can be adjusted to 3 pixels wide. FIG. 6 is merely an example, and embodiments are not limited thereto.

In FIG. 6, the adjustment of scan-line width is used as an example; however, the width of marker-lines can also be adjusted. As needed, the widths of multiple scan-lines in one of the scan-line patterns Psl1 to PslI in FIG. 1 can be increased, and/or the widths of multiple marker-lines in one of the marker-line patterns Pml1 to PmlJ can be increased. Alternatively, the widths of multiple scan-lines in one of the scan-line patterns Psl1 to PslI in FIG. 1 can be reduced, and/or the widths of multiple marker-lines in one of the marker-line patterns Pml1 to PmlJ can be reduced.

Increasing the line widths can make the line images in the reflected pattern clearer for easier recognition. On the other hand, reducing the line widths allows the light pattern reflected by the object 199 to present more detailed shapes of the object 199, thus meeting the demands for higher precision. Therefore, the line widths can be adjusted as needed.

The width of the marker-line and the corresponding scan-line can be different or the same. For example, the width of marker-line mla in FIG. 1 can be different from the width of scan-line sla′. Alternatively, the width of marker-line mla in FIG. 1 can be the same as the width of scan-line sla′.

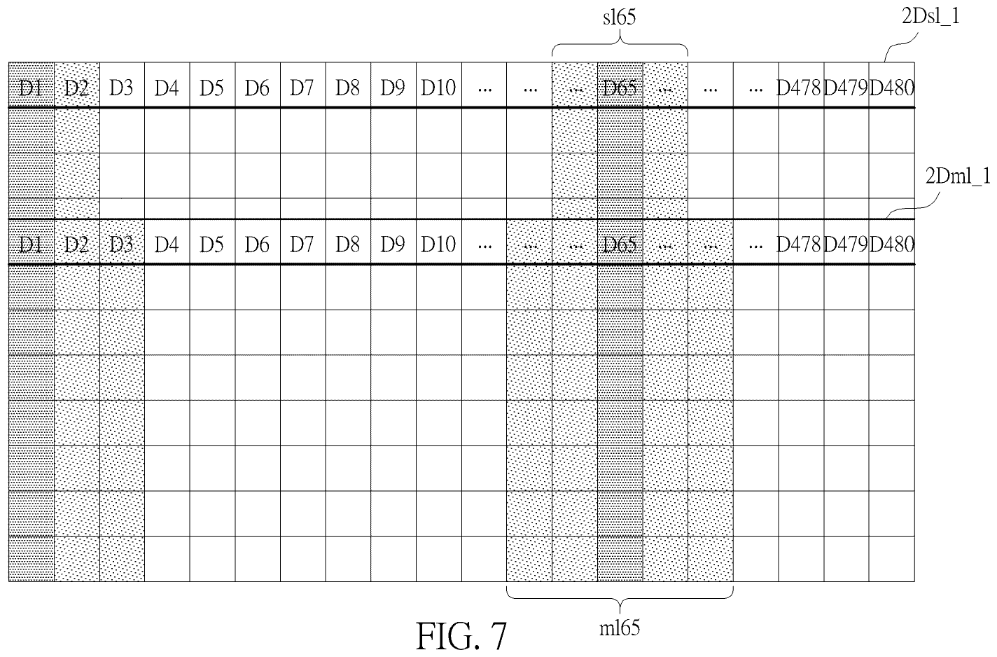

FIG. 7 to FIG. 9 illustrate the alignment of scan-line sla′ and the corresponding marker-line mla in FIG. 1 in different embodiments. FIG. 7 to FIG. 9 may be corresponding to Step 250 of FIG. 2 and Step 320 and Step 330 of FIG. 3. In examples shown in FIG. 7 to FIG. 9, the scan-line sla′ is the scan-line s165 (with the code D65), and the marker-line mla is the marker-line ml65 (with the code D65)

In FIG. 7, the center line of marker-line ml65 can be aligned with the center line of scan-line sl65. Therefore, the control unit 140 of the image processing system 100 can detect the position of the scan-line sl65 according to the position of the marker-line ml65.

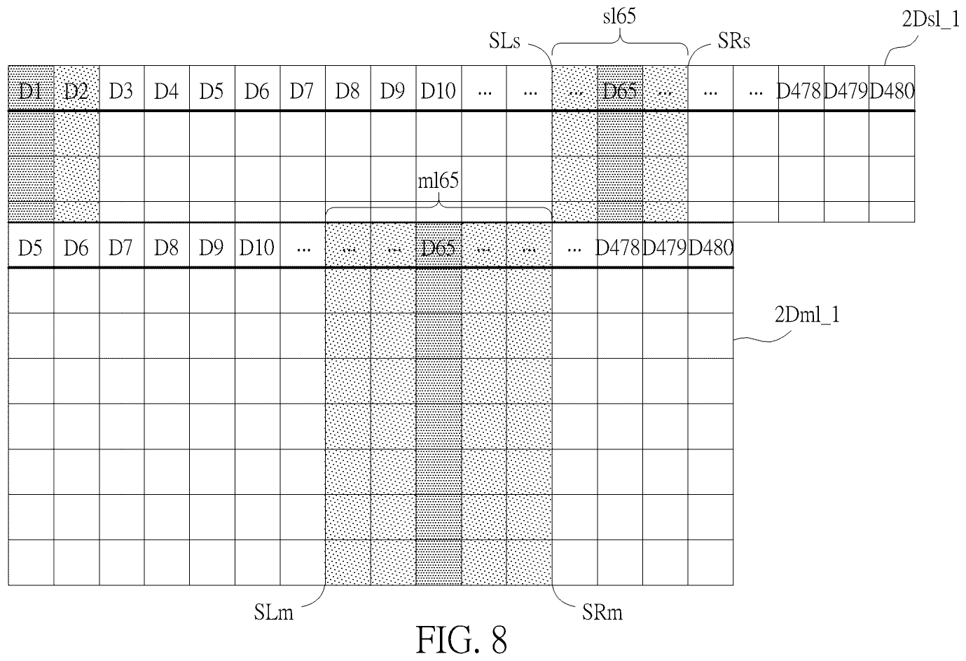

In FIG. 8, the right boundary SRm of the marker-line ml65 may be aligned with the left boundary SLs of the scan-line sl65. FIG. 8 is merely an example. According to embodiments, one of the left boundary (SLm in FIG. 8) and the right boundary (SRm in FIG. 8) of the marker-line mla may be aligned with one of the left boundary (SLs in FIG. 8) and the right boundary (SRs in FIG. 8) of the scan-line sla′, resulting in four types of alignment.
(Alignment Type 1) The right boundary SRm of the marker-line mla may be aligned with the left boundary SLs of the scan-line sla′;
(Alignment Type 2) The right boundary SRm of the marker-line mla may be aligned with the right boundary SRs of the scan-line sla′;
(Alignment Type 3) The left boundary SLm of the marker-line mla may be aligned with the right boundary SRs of the scan-line sla′; and
(Alignment Type 4) The left boundary SLm of the marker-line mla may be aligned with the left boundary SLs of the scan-line sla′.

FIG. 8 shows a diagram of Alignment Type 1 as an example. Alignment Type 2, Alignment Type 3, and Alignment Type 4 may be realized by adjusting the positions of the marker-line mla and/or the scan-line sla′.

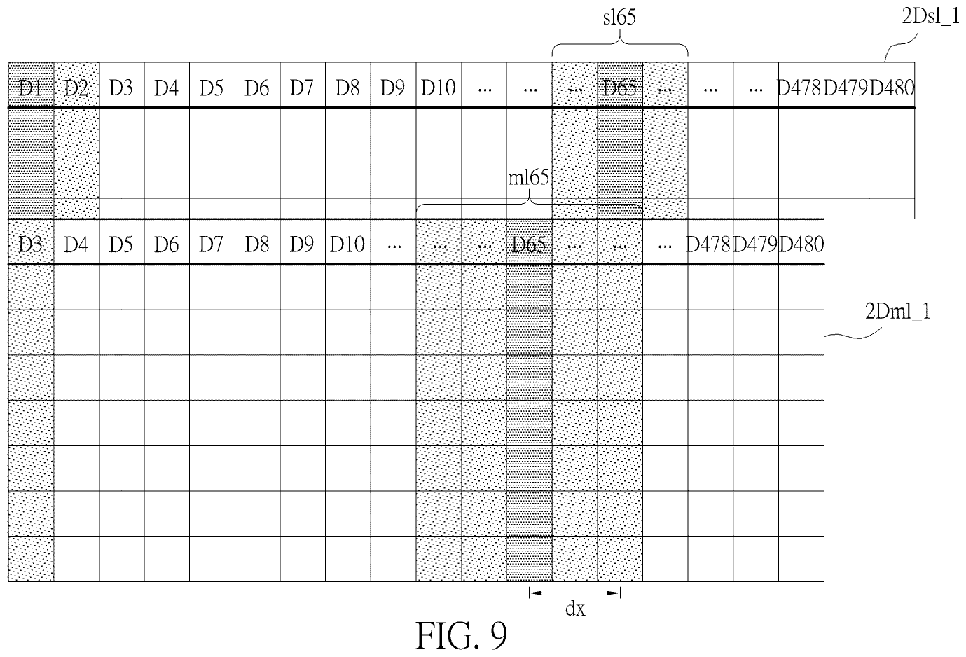

FIG. 9 shows a diagram of alignment according to another embodiment. As shown in FIG. 9, a centerline of the a-th marker-line mla (e.g., ml65) and a centerline of the a′-th scan-line (e.g., sl65) may be separated by a fixed distance dx. The fixed distance dx may be an integer multiple n of the pixel width, where n may be an integer.

In the text, multiple scan-lines in each scan-line pattern may be separated by a first fixed distance between two of adjacent scan-lines, and multiple marker-lines in each marker-line pattern may be separated by a second fixed distance between two of adjacent marker-lines. The first fixed distance may be greater than, less than, or equal to the second fixed distance. In other words, in the line pattern, multiple lines may be regularly and repeatedly arranged.

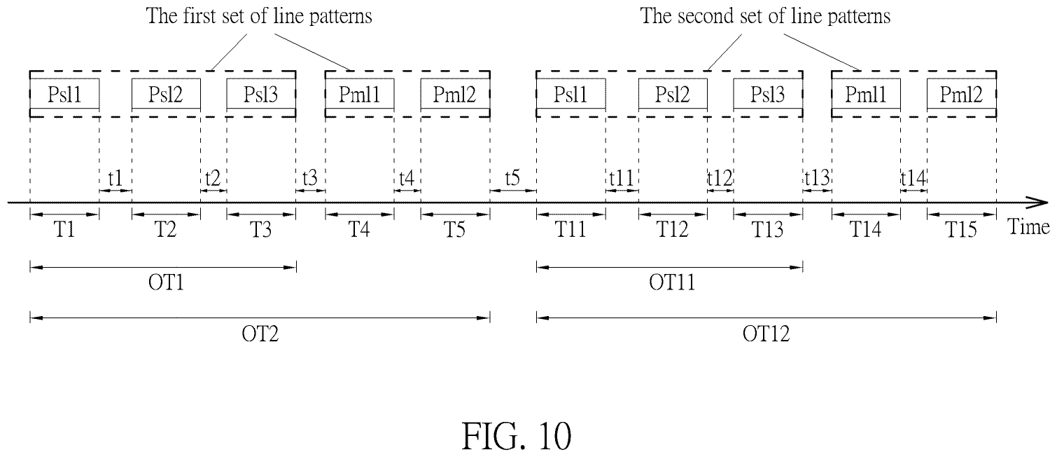

FIG. 10 shows a timing chart for projecting the scan-line patterns Psl1 to Psl3 and marker-line patterns Pml1 and Pml2 onto the object 199 in an embodiment. FIG. 10 may be an example where I=3 and J=2 in FIG. 1. The horizontal axis of FIG. 10 represents the time axis. As shown in FIG. 10, during time periods T1 to T5, the scan-line pattern Psl1, scan-line pattern Psl2, scan-line pattern Psl3, marker-line pattern Pml1, and marker-line pattern Pml2 may be sequentially projected. There may be a time interval t1 between the time periods T1 and T2, a time interval t2 between the time periods T2 and T3, a time interval t3 between the time periods T3 and T4, and a time interval t4 between the time periods T4 and T5. The scan-line patterns Psl1 to Psl3 and marker-line patterns Pml1 and Pml2 are corresponding line patterns. That is, the marker-line patterns Pml1 and Pml2 may be used to identify the scan-line patterns Psl1 to Psl3. Therefore, as previously described, the projection of the scan-line patterns Psl1 to Psl3 and the marker-line patterns Pml1 and Pml2 should be executed within a short period of time and without taking too much time to avoid recognition errors.

As shown in FIG. 10, after projecting the scan-line patterns Psl1 to Psl3 and the marker-line patterns Pml1 and Pml2, a period t5 may elapse before again projecting the scan-line patterns Psl1 to Psl3 and the marker-line patterns Pml1 and Pml2 to detect the next part of the object 199. During the time periods T1, T2, T3, T4, and T5, one set of line patterns may be projected, while during the time periods T11, T12, T13, T14, and T15, the next set of line patterns may be projected.

Each of the time periods T1, T2, T3, T4, and T5 may be the operating period for projecting line patterns, that is, the exposure period for projecting the line patterns. The time periods t1, t2, t3, and t4 may be the switching times for switching the line patterns. The time period t5 may be the set period between projecting one set of line patterns and projecting the next set of line patterns.

Similar to the projection of the previous set of line patterns, the time periods T11, T12, T13, T14, and T15 may be the exposure periods for projecting the line patterns, and the time periods t11, t12, t13, and t14 may be the switching times for switching the line patterns.

In a preferred embodiment, the time periods t1, t2, t3, and t4 may be of equal length, and the time periods t11, t12, t13, and t14 may also be of equal length. The time period t5 may be greater than, equal to, or less than one of the time periods t1, t2, t3, and t4. In an embodiment, the time periods t1, t2, t3, t4, and t5 may be substantially of equal length.

For example, each of the time periods T1, T2, T3, T4, T5, T11, T12, T13, T14, and T15 may be approximately 2000 to 7500 microseconds (us), and each of the time periods t1, t2, t3, t4, t5, t11, t12, t13, and t14 may be approximately 75 to 300 microseconds, and embodiments are not limited thereto.

FIG. 10 takes I=3 as an example. As shown in FIG. 10, the first scan-line pattern to the I-th scan-line pattern (e.g., Psl1, Psl2, Psl3) may be projected onto the object within a predetermined period OT1. The duration of projecting and exposing the first scan-line pattern to the I-th scan-line pattern (e.g., Psl1, Psl2, Psl3) onto the object is the first operating period (e.g., the sum of T1, T2, and T3). The predetermined period OT1 may be less than 103%, 105%, or 110% of the first operating period (e.g., the sum of T1, T2, and T3) to avoid an excessive interval between the projection of two line patterns.

FIG. 10 takes I=3 and J=2 as an example. As shown in FIG. 10, the first scan-line pattern to the I-th scan-line pattern (e.g., Psl1 to Psl3) and the first marker-line pattern to the J-th marker-line pattern (e.g., Pml1 to Pml2) may be projected onto the object within a predetermined period OT2. The duration of projecting and exposing the first scan-line pattern to the I-th scan-line pattern (e.g., Psl1 to Psl3) and the first marker-line pattern to the J-th marker-line pattern (e.g., Pml1 to Pml2) onto the object is the second operating period (e.g., the sum of T1, T2, T3, T4, and T5). The predetermined period OT2 may be less than 103%, 105%, or 110% of the second operating period (e.g., the sum of T1, T2, T3, T4, and T5) to avoid an excessive interval between the projection of two line patterns.

When projecting the first scan-line pattern to the I-th scan-line pattern (e.g., Psl1, Psl2, Psl3 in FIG. 10), the sum of multiple switching times between projecting consecutive scan-line patterns (e.g., the sum of t1 and t2 in FIG. 10) may be 1% to 5% or 2% to 3% of the first operating period for projecting the first scan-line pattern to the I-th scan-line pattern (e.g., the sum of T1, T2, and T3 in FIG. 10).

When projecting the first scan-line pattern to the I-th scan-line pattern, and the first marker-line pattern to the J-th marker-line pattern (e.g., Psl1, Psl2, Psl3, Pml1, Pml2 in FIG. 10) onto the object, the sum of multiple switching times between projecting consecutive line patterns (e.g., the sum of t1, t2, t3, t4) may be 1% to 5% or 2% to 3% of the second operating period for projecting the first scan-line pattern to the I-th scan-line pattern and the first marker-line pattern to the J-th marker-line pattern (e.g., the sum of T1, T2, T3, T4, T5 in FIG. 10).

After projecting the first set of line patterns during the predetermined period OT1 and the elapsed period t5, the second set of line patterns may be projected during the predetermined period OT12.

Similar to the aforementioned, the proportional relationships of the predetermined period OT11, the predetermined period OT12, the time periods T11, T12, T13, T14, T15, t11, t12, t13, and t14 corresponding to the set of second line patterns may be similar to the proportional relationships of the predetermined period OT1, the predetermined period OT2, the time periods T1, T2, T3, T4, T5, t1, t2, t3, and t4 corresponding to the set of first line patterns. Therefore, they are not repeated here. According to an embodiment, the interval between projecting two line patterns should not be too long to avoid a decrease in sampling accuracy.

The lengths of the predetermined period OT2 corresponding to the first set of line patterns and the predetermined period OT12 corresponding to the second set of line patterns can be the same or different and can be set according to the requirements.

During the predetermined period OT2 for projecting the set of first line patterns, the total switching time for switching the line patterns (i.e., the sum of t1, t2, t3, and t4) may be 1% to 5% or 2% to 3% of the exposure period for projecting the line patterns (i.e., the sum of T1, T2, T3, T4, and T5).

Even if the scanner is moved too quickly or the user's hand shakes while using the scanner, causing unexpected linear displacement or angular displacement, if the total switching time for switching the line patterns and the exposure period for projecting the line patterns comply with the aforementioned proportional relationships, the interference caused by the displacement can be reduced, thereby improving the accuracy of image decoding and enhancing the quality of the generated three-dimensional image.

In FIG. 10, the order of projecting the line patterns is merely an example, and other sequences also fall within the scope of the embodiments. For instance, besides the order in FIG. 10, the line patterns can also be projected in the following sequence as indicated by the arrows: the scan-line pattern Psl1→the marker-line pattern Pml1→the scan-line pattern Psl2→the scan-line pattern Psl3→the marker-line pattern Pml2. The order described here is just an example, and other sequences are also permissible. The sequence can be adjusted according to the operational requirements of the image processing system 100 in FIG. 1.

In summary, according to the aforementioned image processing system and image processing method, suitable scan-line patterns and marker-line patterns can be generated to detect objects. The disclosed image processing system and image processing method have provided solutions regarding the coding deployment, positional arrangement, correlation establishment, line pattern adjustment, alignment settings, and projection timing of the scan-lines and marker-lines. Therefore, it can effectively improve the accuracy of object detection and enhance the quality of the generated three-dimensional images of the objects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method for detecting an object, comprising:
performing an encoding operation to generate a first code to a W-th code according to W regions of a pattern generator;
generating a first scan-line pattern to an I-th scan-line pattern, wherein the first scan-line pattern to the I-th scan-line pattern each comprise a plurality of scan-lines, and each scan-line is corresponding to one of the first code to the W-th code, respectively;
projecting the first scan-line pattern to the I-th scan-line pattern onto the object within a first predetermined period; and
generating a three-dimensional image of the object according to the first scan-line pattern to the I-th scan-line pattern reflected by the object;
wherein at least a first operation period is required for projecting the first scan-line pattern to the I-th scan-line pattern onto the object, and the first predetermined period is less than 110% of the first operation period;
wherein W is an integer greater than zero, and I is an integer greater than 1.

2. The method of claim 1, wherein:
when projecting the first scan-line pattern to the I-th scan-line pattern, a total switching time between projecting consecutive patterns of the first scan-line pattern to the I-th scan-line pattern is 1% to 5% of the first operation period.

3. The method of claim 1, wherein an i-th scan-line pattern from the first scan-line pattern to the I-th scan-line pattern comprises a plurality of scan-lines, a k-th code of a plurality of codes corresponding to the plurality of scan-lines of the i-th scan-line pattern is represented as f(xᵢ, cₖ):
$$f ( {x}_{i} , {c}_{k} ) = {x}_{i} + {c}_{k} \times y ;$$
wherein f( ) is a first predetermined function, i, xᵢ, k, and y are integers greater than zero, cₖ is an integer not less than zero, the k-th code is corresponding to one of the first code to the W-th code, i≤I, k≤W, xᵢ is a parameter that changes with i, and cₖ is a parameter that changes with k.

4. The method of claim 1, further comprising:
generating a first marker-line pattern to a J-th marker-line pattern, where the first marker-line pattern to the J-th marker-line pattern each comprise a plurality of marker-lines, and each marker-line corresponds to one of the first code to the W-th code, respectively;
projecting the first scan-line pattern to the I-th scan-line pattern, and the first marker-line pattern to the J-th marker-line pattern onto the object within a second predetermined period;
generating another three-dimensional image of the object according to the first scan-line pattern to the I-th scan-line pattern, and the first marker-line pattern to the J-th marker-line pattern reflected by the object;
wherein an a-th marker-line is corresponding to an a′-th scan-line, the a-th marker-line reflected by the object is used to identify the a′-th scan-line reflected by the object, J is an integer greater than or equal to 1, a and a′ are integers greater than zero, a≤W, and a′≤W;
wherein at least a second operation period is required for projecting the first scan-line pattern to the I-th scan-line pattern and the first marker-line pattern to the J-th marker-line pattern onto the object, and the second predetermined period is less than 110% of the second operation period.

5. The method of claim 4, further comprising:
increasing widths of a plurality of scan-lines of one scan-line pattern from the first scan-line pattern to the I-th scan-line pattern, and/or increasing widths of a plurality of marker-lines of one marker-line pattern from the first marker-line pattern to the J-th marker-line pattern; or
reducing widths of a plurality of scan-lines of one scan-line pattern from the first scan-line pattern to the I-th scan-line pattern, and/or reducing widths of a plurality of marker-lines of one marker-line pattern from the first marker-line pattern to the J-th marker-line pattern.

6. The method of claim 4, wherein one of the first scan-line pattern to the I-th scan-line pattern is corresponding to a first light wavelength, and one of the first marker-line pattern to the J-th marker-line pattern is corresponding to a second light wavelength.

7. The method of claim 4, further comprising:
arranging each marker-line into one of the first marker-line pattern to the J-th marker-line pattern.

8. The method of claim 4, wherein a k′-th code of a plurality of codes corresponding to a plurality of marker-lines of the first marker-line pattern to the J-th marker-line pattern is represented as g(c_{k′}):
$$g ( {c}_{{k}^{′}} ) = {x}^{′} + {c}_{k}^{′} \times {y}^{′} ;$$
wherein g( ) is a second predetermined function, the k′-th code is corresponding to one of the first code to the W-th code, k′, x′, and y′ are positive integers greater than zero, cₖ′ is an integer not less than zero, k′≤W, and cₖ′ is a parameter that changes with k′, x′ and y′ are parameters corresponding to the first scan-line pattern to the I-th scan-line pattern.

9. The method of claim 8, wherein cₖ′ is equal to (k′−1)×T, and T is an integer greater than zero.

10. The method of claim 4, wherein:
a centerline of the a-th marker-line is aligned with a centerline of the a′-th scan-line; or
a left boundary of the a-th marker-line is aligned with one of a left boundary and a right boundary of the a′-th scan-line; or
a right boundary of the a-th marker-line is aligned with one of the left boundary and the right boundary of the a′-th scan-line; or
the centerline of the a-th marker-line and the centerline of the a′-th scan-line are separated by a fixed distance.

11. The method of claim 4, wherein:
each of the first scan-line pattern to the I-th scan-line pattern comprises a plurality of scan-lines, where two of adjacent scan-lines are separated by a first fixed distance; and
each of the first marker-line pattern to the J-th marker-line pattern comprises a plurality of marker-lines, where two of adjacent marker-lines are separated by a second fixed distance.

12. The method of claim 4, wherein:
when projecting the first scan-line pattern to the I-th scan-line pattern and the first marker-line pattern to the J-th marker-line pattern onto the object, a total switching time between projecting two consecutive patterns of the first scan-line pattern to the I-th scan-line pattern and the first marker-line pattern to the J-th marker-line pattern is 1% to 5% of the second operation period.

13. The method of claim 4, wherein:
a width of the a-th marker-line is different from a width of the a′-th scan-line.

14. The method of claim 4, wherein:
a width of the a-th marker-line is equal to a width of the a′-th scan-line.

15. An image processing system for detecting an object, comprising:
a projection light source, configured to generate projection light;
a pattern generator, configured to use the projection light to generate a first scan-line pattern to an I-th scan-line pattern, where each of the first scan-line pattern to the I-th scan-line pattern comprises a plurality of scan-lines;
an imaging unit, configured to project the first scan-line pattern to the I-th scan-line pattern onto the object within a first predetermined period, and to receive the first scan-line pattern to the I-th scan-line pattern reflected by the object; and
a control unit, configured to perform an encoding operation to generate a first code to a W-th code according to W regions of the pattern generator, arrange each scan-line to be corresponding to one of the first code to the W-th code respectively, and generate a three-dimensional image of the object according to the first scan-line pattern to the I-th scan-line pattern reflected by the object;
wherein at least a first operation period is required for projecting the first scan-line pattern to the I-th scan-line pattern onto the object, and the first predetermined period is less than 110% of the first operation period; and
W is an integer greater than zero, and I is an integer greater than 1.

16. The system of claim 15, wherein:
the pattern generator is further configured to use the projection light to generate a first marker-line pattern to a J-th marker-line pattern, where each of the first marker-line pattern to the J-th marker-line pattern comprises a plurality of marker-lines;
the imaging unit is further configured to project the first scan-line pattern to the I-th scan-line pattern and the first marker-line pattern to the J-th marker-line pattern onto the object within a second predetermined period, and to receive the first scan-line pattern to the I-th scan-line pattern and the first marker-line pattern to the J-th marker-line pattern reflected by the object; and
the control unit is further configured to arrange each marker-line to be corresponding to one of the first code to the W-th code respectively, and generate another three-dimensional image of the object according to the first scan-line pattern to the I-th scan-line pattern and the first marker-line pattern to the J-th marker-line pattern reflected by the object;
wherein an a-th marker-line is corresponding to an a′-th scan-line, the a-th marker-line reflected by the object is used to identify the a′-th scan-line reflected by the object, J is an integer greater than or equal to 1, a and a′ are integers greater than zero, a≤W, and a′≤W;
wherein at least a second operation period is required for projecting the first scan-line pattern to the I-th scan-line pattern and the first marker-line pattern to the J-th marker-line pattern onto the object, and the second predetermined period is less than 110% of the second operation period.

17. The system of claim 16, wherein one of the first scan-line pattern to the I-th scan-line pattern is corresponding to a first light wavelength, and one of the first marker-line pattern to the J-th marker-line pattern is corresponding to a second light wavelength.

18. The method of claim 16, wherein:
a width of the a-th marker-line is different from a width of the a′-th scan-line.

19. The method of claim 16, wherein:
a width of the a-th marker-line is equal to a width of the a′-th scan-line.

20. The method of claim 16, wherein:
a centerline of the a-th marker-line is aligned with a centerline of the a′-th scan-line; or
a left boundary of the a-th marker-line is aligned with one of a left boundary and a right boundary of the a′-th scan-line; or
a right boundary of the a-th marker-line is aligned with one of the left boundary and the right boundary of the a′-th scan-line; or
the centerline of the a-th marker-line and the centerline of the a′-th scan-line are separated by a fixed distance.
